(19) United States
(12) Patent Application Publication
(10) Pub. No.: US 2009/0214338 A1
(43) Pub. Date: Aug. 27, 2009

(54) Propeller Propulsion Systems Using Mixer Ejectors

(76) Inventors: Michael J. Werle, West Hartford, CT (US); Walter M. Presz, JR., Wilbraham, MA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/053,695

(22) Filed: Mar. 24, 2008

Related U.S. Application Data
(60) Provisional application No. 60/919,588, filed on Mar. 23, 2007.

(51) Int. Cl. F04D 29/52; F04D 29/32

(52) U.S. Cl. 415/220; 415/228

(57) ABSTRACT

A Mixer-Ejector Prop System (MEPS) is presented as a new, unique and improved concept for injecting power and producing force in flowing fluids such as air or water. MEPS incorporates advanced flow mixing technology, single and multi-stage ejector technology, aircraft and propulsion aerodynamics and noise abatement technologies in a unique manner to fluid-dynamically improve the operational effectiveness and efficiency for subsonic flow velocities.

### RELATED APPLICATION

This application claims priority from U.S. Provisional Patent Applications Ser. No. 60/919,588, filed Mar. 23, 2007. Applicants hereby incorporate the disclosure of that application by reference.

### BACKGROUND OF INVENTION

A propeller rotor device, termed the “prop”, is a series of aerodynamic blades that are rotated by a power source such that energy is added to the flow passing through the prop. In most applications such added energy is used to generate an axial, propulsive force at speeds less than 300 miles per hour, hereinafter “low speed flow”. The number, shape and design of the rotating prop blades can vary. Two example applications of such props are in the propulsion systems of aircraft and watercraft. Variations of such props are used in axial flow rotors of a compressor. They are also used to drive blower and vacuum systems.

The ability of a prop to convert power to force when placed in a stream of very large width compared to its diameter is limited by the amount and speed of the fluid it draws into and through the area swept by the propeller. To increase beyond this level, shrouds or ducts surrounding the propeller have been used. There has been considerable effort and discussion in the literature by Kort, Abella, Hollmann, Kuchemann, Lazareff and de Piolenc concerning the potential for such shrouded propeller propulsion. Additionally, while ejector-based propulsion augmentation has been studied extensively for over 60 years (see Prandtl, Heiser, Presz and Werle), only limited attention has been given its application to subsonic/incompressible propeller propulsors.

Properly designed shrouds cause the oncoming flow to speed up as it is concentrated into the center of the duct containing the prop. In general, for a properly designed rotor and shroud combination, this increased flow speed at the prop causes increased force, termed “amplification”, on the combined system of the prop and shroud. A significant portion of the total force can occur on the shroud. Amplification values 1.5 and 2 have been recorded for such shrouded rotors.

Ejectors are well known and documented fluid jet pumps that draw flow into a system and thereby increase the flow rate through that system. Mixer/ejectors are short compact versions of such jet pumps that are relatively insensitive to incoming flow conditions and have been used extensively in high speed jet propulsion applications involving flow velocities near or above the speed of sound. See, for example, U.S. Pat. No. 5,761,900 to Dr. Walter M. Presz, Jr, which also uses a mixer downstream to increase thrust while reducing noise from the discharge. Dr. Presz is a co-inventor in the present application.

It is a primary objective to present a force generating shrouded axial flow prop system for low speed flow that employs advanced flow mixing and control devices to increase its amplification and minimize the impact of its attendant flow field on the surrounding environment and/or other props in its near vicinity.

It is another primary object of the current invention to present a force generating axial flow prop system that employs advanced fluid dynamic ejector principles to cause force amplification.

It is a more specific objective, commensurate with the above-listed objectives, to combine ejector concepts with high efficiency flow mixing devices, hereinafter “mixer-ejector”, concepts in a force generating shrouded axial flow prop system for low speed flows.

### SUMMARY OF INVENTION

A mixer-ejector prop system (nicknamed the “MEPS”) for generating force is disclosed that combines fluid dynamic ejector concepts, advanced flow mixing and control devices and an adjustable prop system.

The MEPS uses aerodynamically contoured shrouds and ejectors surrounding an axial flow prop system which consists of one or more rows of blades to inject power into an oncoming fluid stream. The shrouds and ejectors are designed and arranged so as to draw the maximum amount of fluid through the prop and to minimize impacts to the environment (such as noise) and other props in its vicinity. Unlike the prior art, MEPS contain shrouds with advanced flow mixing and control devices such as lobed or slotted mixers and/or one or more ejector pumps. Additionally, it may contain sound absorption materials on the interior surfaces, internal flow blocker doors for reversing the flow and force direction, multiple flow inlet and outlet ports which may be noncircular and inlet and outlet ports whose axes are not coincident with the axis of rotation of the prop. First-principles-based theoretical analysis of MEPS indicate that they can produce three or more time the force of their un-shrouded counterparts for the same power level and frontal area.

In the first preferred embodiment, the MEPS comprises: an axial flow prop surrounded by an aerodynamically contoured prop shroud incorporating mixing devices in its terminus region and a separate ejector duct overlapping but generally aft of said prop shroud, which itself may incorporate advanced mixing devices in its terminus region.

In the second preferred embodiment, the MEPS comprises: an axial flow prop surrounded by an aerodynamically contoured prop shroud incorporating mixing devices in its terminus region.

Other objects and advantages of the current invention will become more readily apparent when the following written description is read in conjunction with the accompanying drawings.

### BRIEF DESCRIPTION OF THE DRAWINGS

FIGS. 1, 2A, 2B, 3A, 3B show MEPS, constructed in accordance with the present invention, having a single stage ejector incorporating either lobed or slotted mixers;

FIGS. 4A, 4B, 5A, 5B show MEPS constructed in accordance with the present invention, having a multistage ejector incorporating either lobed or slotted mixers;

FIGS. 6, 7, 8, 9A, 9B, 10A, 10B, 11A, 11B, 12, 13 show MEPS incorporating mixing devices in the non-circular inlets and outlet combinations;

FIGS. 14A, 14B, 15 show MEPS with a adjustable rotor and stator combinations;

FIG. 16 shows a MEPS constructed with the rotor blade power transmitted at the rotor inner ring;

FIG. 17 shows a MEPS constructed with the rotor blade power transmitted at the rotor outer ring and sound absorption in the inner surface of the shrouds;

FIG. 18 shows a MEPS constructed with blocker doors incorporated in the shroud to reverse or deflect the thrust generated;

FIGS. 19A, 19B, 20A, 20B show a MEPS constructed with articulating ejector shrouds for thrust vectoring;

FIGS. 21A, 21B present a variation of Applicant's MEPS wherein the system has two separate and independent inlet sections;

FIGS. 21A, 21B, 22, present variations of Applicant's MEPS wherein the axes of the various flow inlets and outlets are offset;

FIGS. 23, 24A, 24B present variations of Applicant's MEPS wherein it is embedded in another entity, such as an aircraft wing;

### DETAILED DESCRIPTION OF PREFERRED EMBODIMENTS

Referring to the drawings in detail, Applicants' novel mixer-ejector propeller system (nicknamed the “MEPS”) is disclosed and like reference numerals refer to like elements. MEPS combines advanced flow mixing devices (hereinafter “MIXERS”), ejector pumps (hereinafter “EJECTORS”) and propellers (hereinafter “PROPs”) elements for increasing force generated in a fluid stream.

The MEPS uses aerodynamically contoured shrouds and ejectors surrounding a propeller system which consists of one or more rows of blades to input power to the oncoming fluid stream. The shrouds and ejectors are designed and arranged so as to draw the maximum amount of fluid through the propeller for maximum propulsion efficiency. First-principles-based theoretical analysis of MEPS indicate that they can increase propulsion by fifty percent or more when compared to the thrust produced by un-shrouded counterpart propellers for the same frontal area and power input.

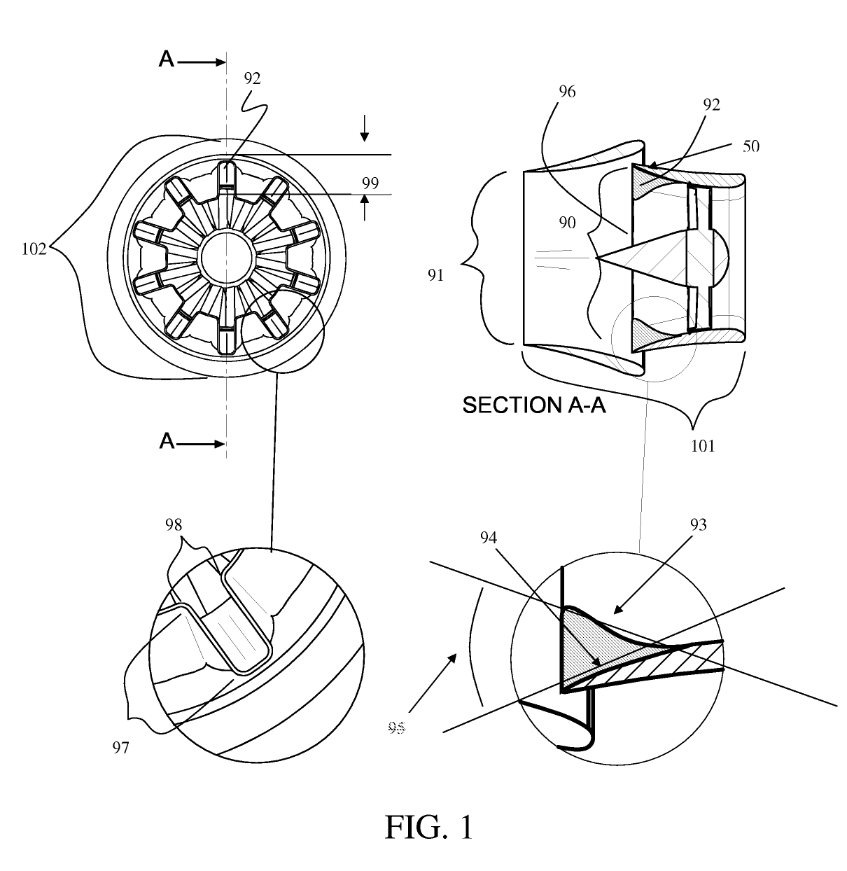

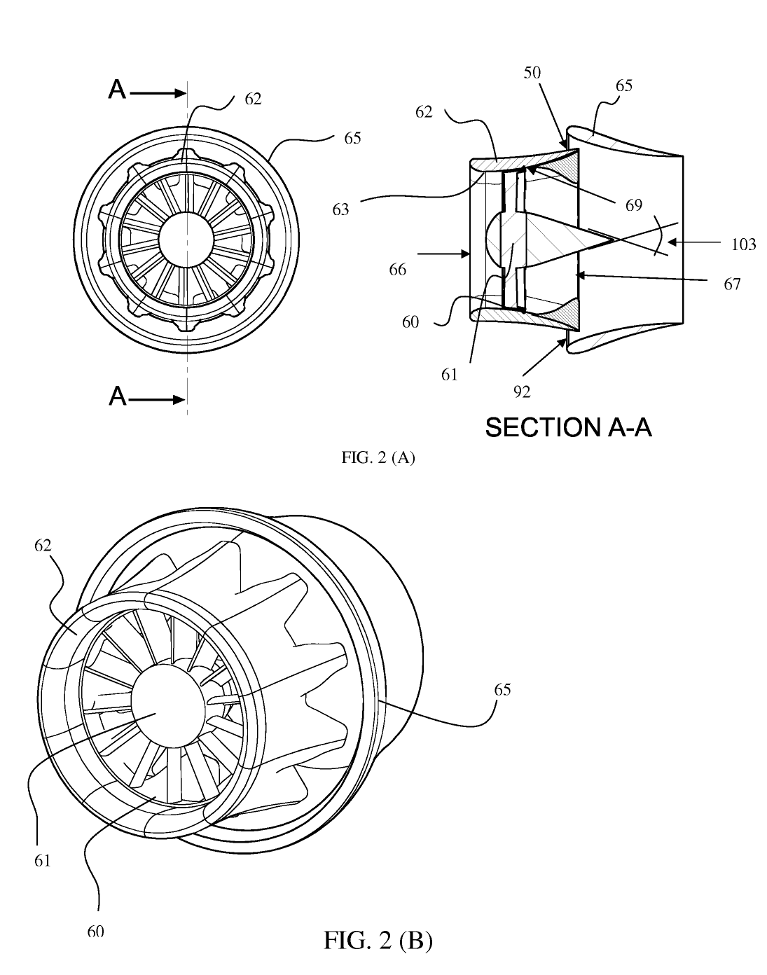

In the first preferred embodiment, the MEPS, as shown in FIGS. 1, 2A, 2B comprises:
f. (FIG. 1) a shrouded propeller with a single stage mixer/ejector jet pump attached to the downstream section of the propeller shroud 50. The area ratio of the ejector pump, as defined by the ejector shroud exit area 91 over the turbine shroud exit area 90 will be between 1.5 and 3.0. The number of lobes 92 would be between six and fourteen. Each lobe will have inner 94 and outer 93 trailing edge angles 95 between 5° and 25° degrees. The primary lobe exit location 96 will be at, or near the entrance location of the ejector shroud. The height 97 to width 98 ratio of the lobe channels will be between 0.5 and 4.5. The mixer penetration 99 will be between 50% and 80%. The length 101 to diameter 102 (L/D) of the overall MEPS system will be between 0.5 and 1.25;
g. a shroud entrance area 66 and exit area 67 (FIG. 2A) that is equal or greater than that of the annulus surrounding the prop.
h. an aerodynamically contoured center-body 61 (FIG. 2A) that has downstream flow angles 103 (FIG. 2B) between five and thirty degrees when measured with respect to the axial direction;
i. a propeller shroud 62 that is aerodynamically shaped (spline surfaces) with camber directed towards the centerline with a minimum area occurring at the plane of the prop 60 and an internal surface 63 that varies smoothly from the entrance plane to the exit plane. Any internal shroud diffusion angles 69 will be less than six degrees when measured with respect to the axial direction. The shroud is aerodynamically shaped to assist guiding the flow into the prop shroud entrance 66, eliminating any flow separation, and delivering smooth flow into the ejector entrance 92. The propeller shroud L/D will be between 0.25 and 1.0.
j. An ejector shroud 65 that is aerodynamically shaped (spline surfaces) with camber directed towards the centerline and an internal surface that varies smoothly from the entrance plane to the exit plane. Any internal shroud diffusion angles will be less than six degrees when measured with respect to the axial direction. The shroud is aerodynamically shaped to assist guiding the flow into the ejector entrance and eliminating any flow separation. The ejector shroud L/D will be between 0.25 and 1.0.
   This first preferred MEPS embodiment will increase propulsion by fifty percent or more when compared to the thrust produced by un-shrouded counterpart propellers for the same frontal area and power input.

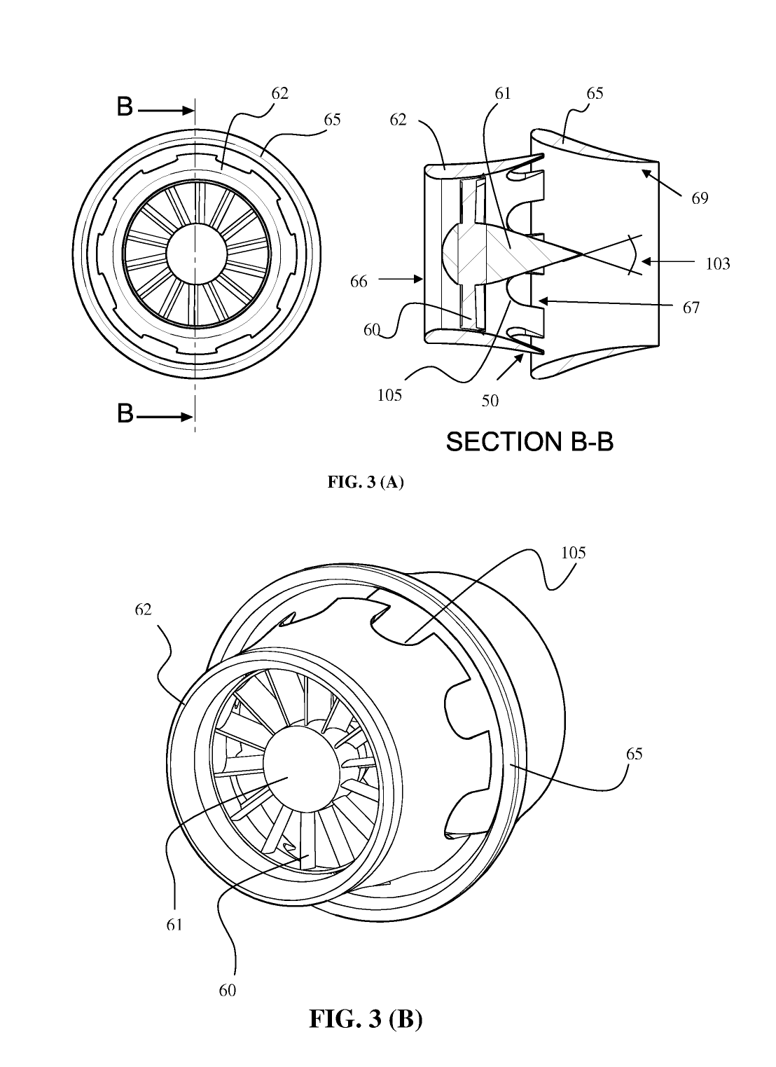

Applicants' second preferred embodiment of MEPS, shown in FIGS. 3A, 3B incorporates slots 105 as mixer enhancing devices instead of forced mixer lobes. The number of slots around the perimeter will be between 6 and 16. Each slot will have a depth to width ratio of 2.0. Such slots increase mixing and shorten the required ejector shroud length.

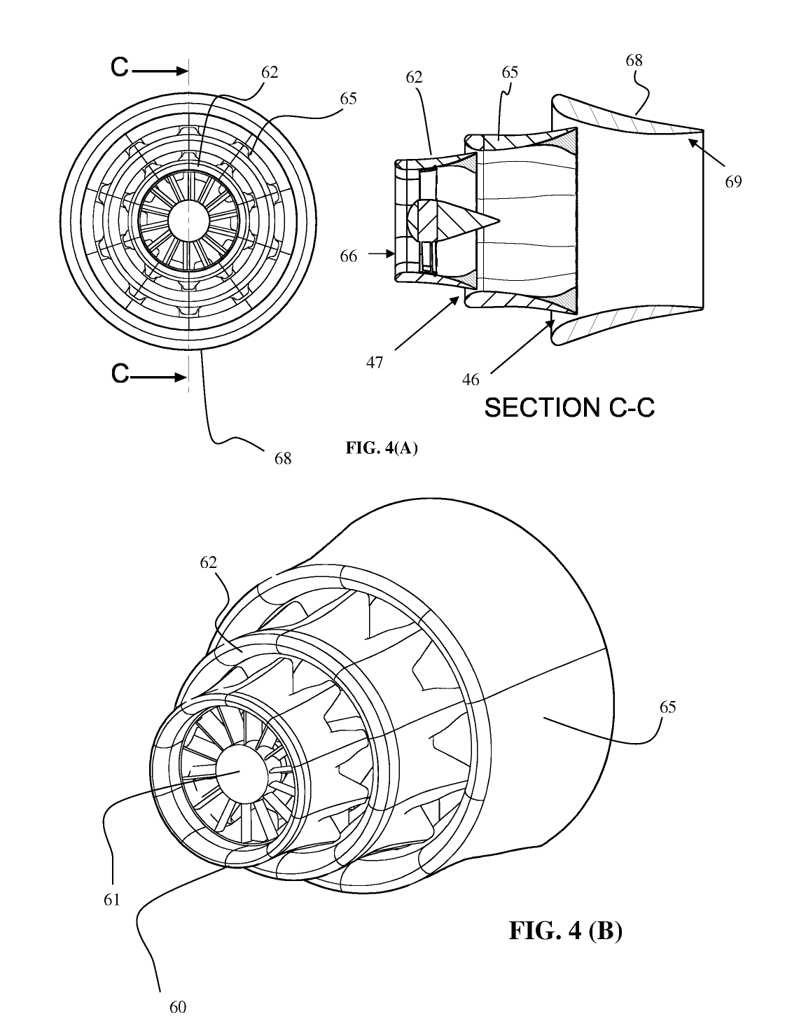

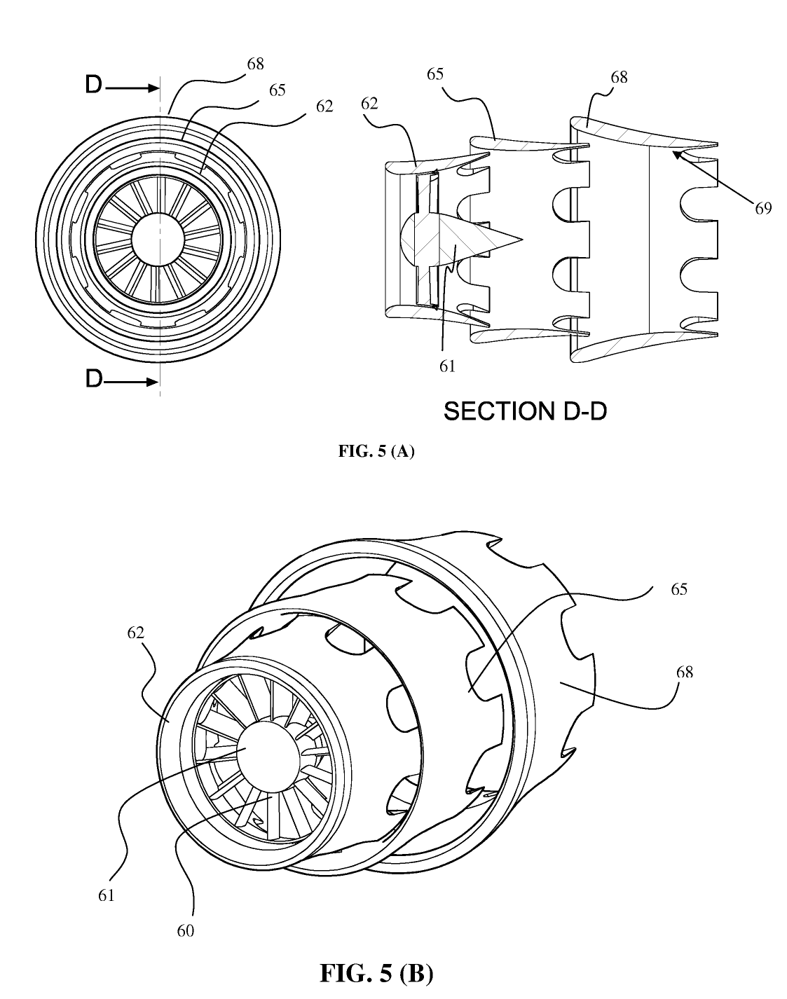

Applicants' third preferred embodiment of MEPS, shown in FIGS. 4A, 4B, 5A, 5B incorporates two-stage ejectors 65, 68 to pump more flow through the propeller for higher thrust benefits. Two ejector stages means two ejector secondary flow inlets 46, 47 which allow more flow to be pumped into the system for higher thrust augmentation. Lobes or slots are used to enhance ejector mixing. Each ejector shroud 65, 68 is aerodynamically shaped (spline surfaces) with camber directed towards the centerline and an internal surface that varies smoothly from the entrance plane to the exit plane. Any internal shroud diffusion angles 69 will be less than six degrees when measured with respect to the axial direction. The shroud is aerodynamically shaped to assist guiding the flow into the ejector entrance and eliminating any flow separation. The ejector shroud L/D will be between 0.25 and 1.0.

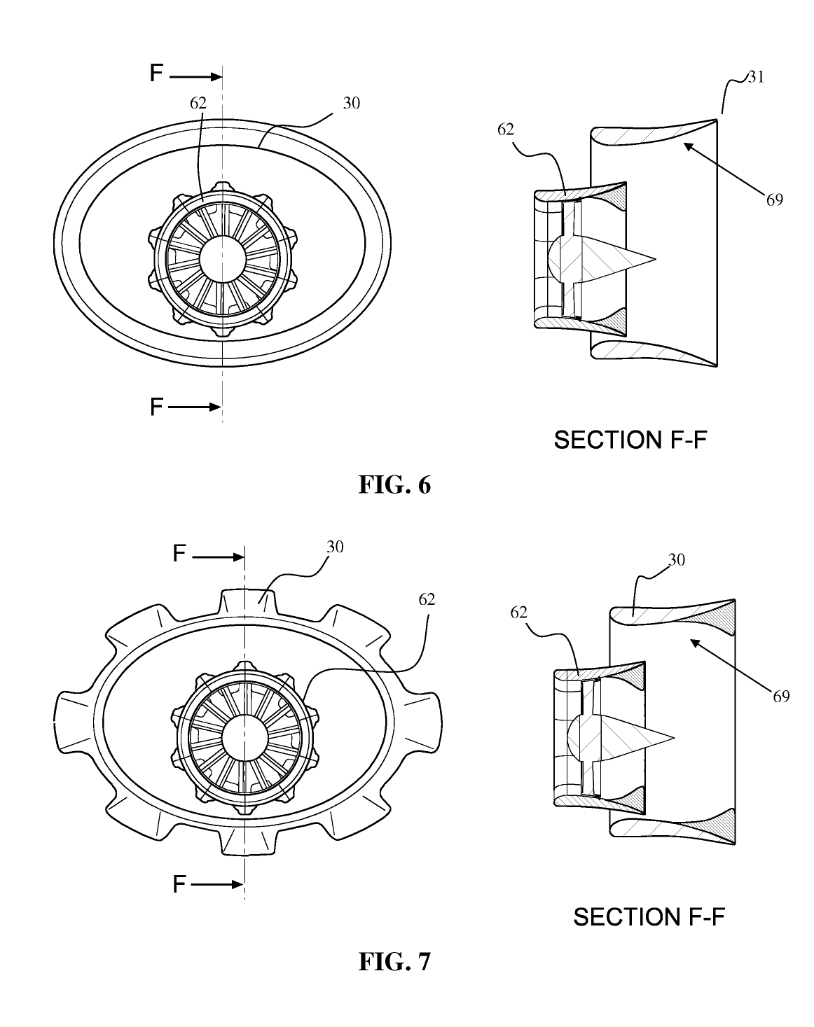

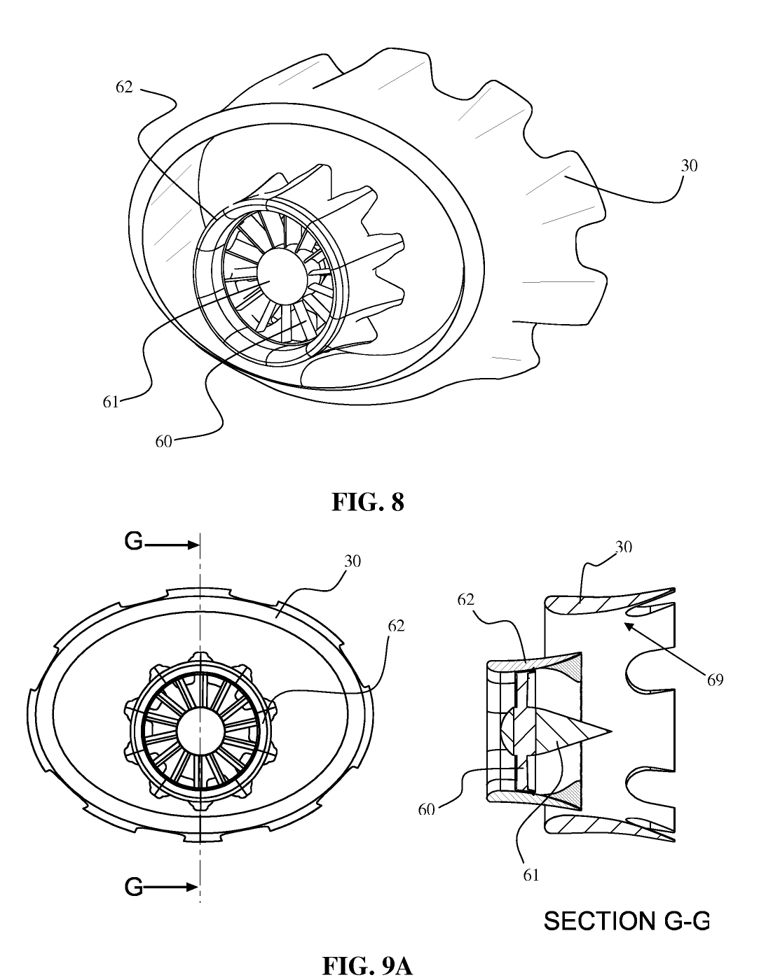

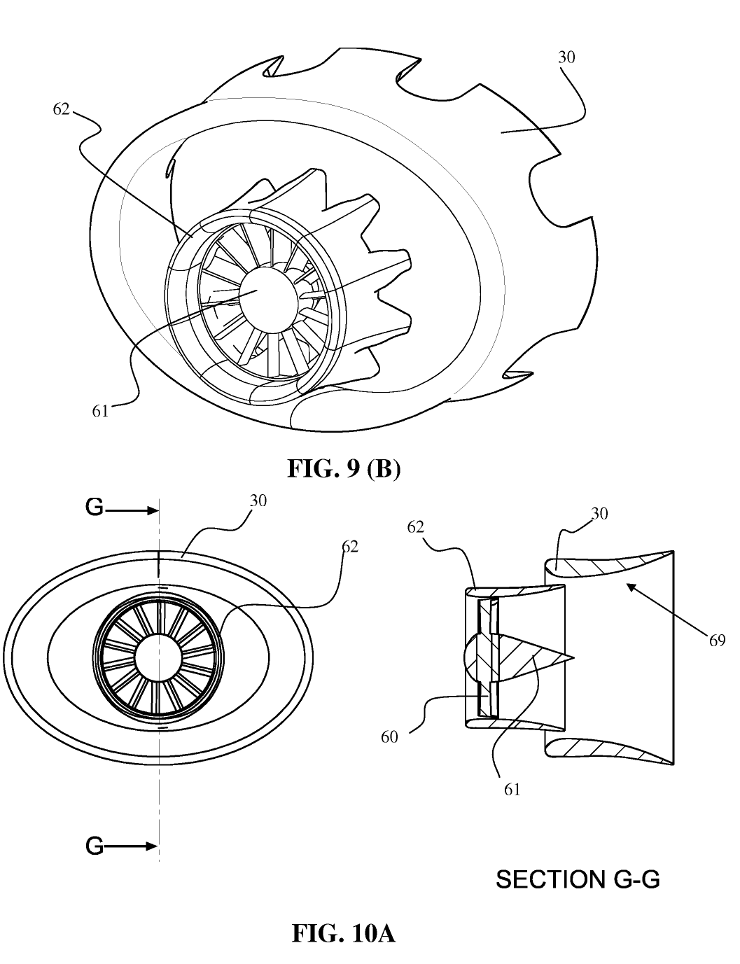

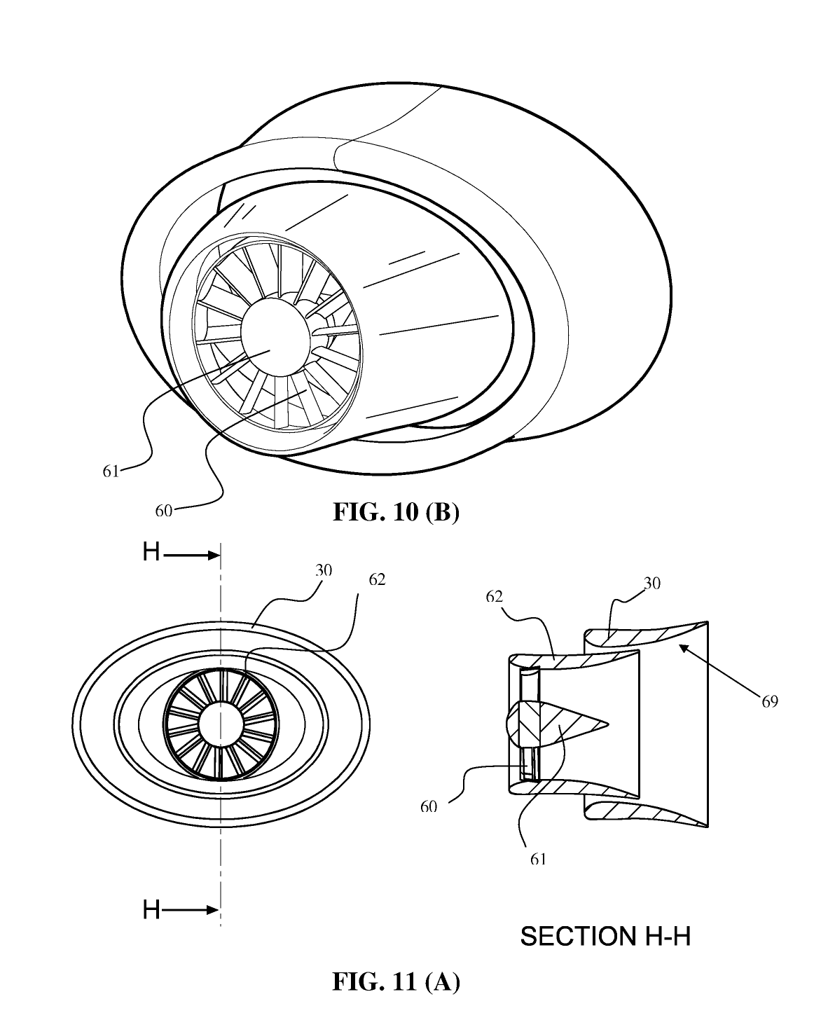

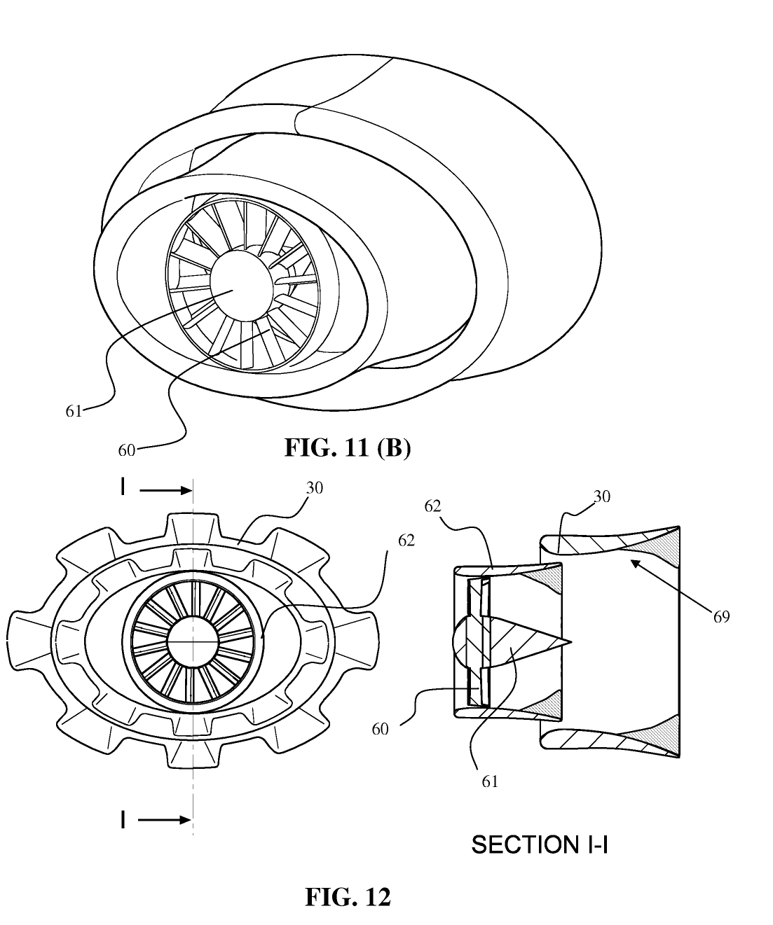

FIGS. 6, 7, 8, 9A, 9B, 10A, 10B, 11A, 11B, 12 present Applicants' MEPS with non-circular flow inlets 30 and/or outlets 31 on either the turbine shroud or ejector shroud so as to allow better control of the flow source and impact of its wake. Lobes or slots can be used to enhance ejector mixing. Each shroud is aerodynamically shaped (spline surfaces) with camber directed towards the centerline and an internal surface that varies smoothly from the entrance plane to the exit plane. Any internal shroud diffusion angles 69 will be less than six degrees when measured with respect to the axial direction. The shroud L/Dh (Dh is the hydraulic diameter) will be between 0.25 and 1.0

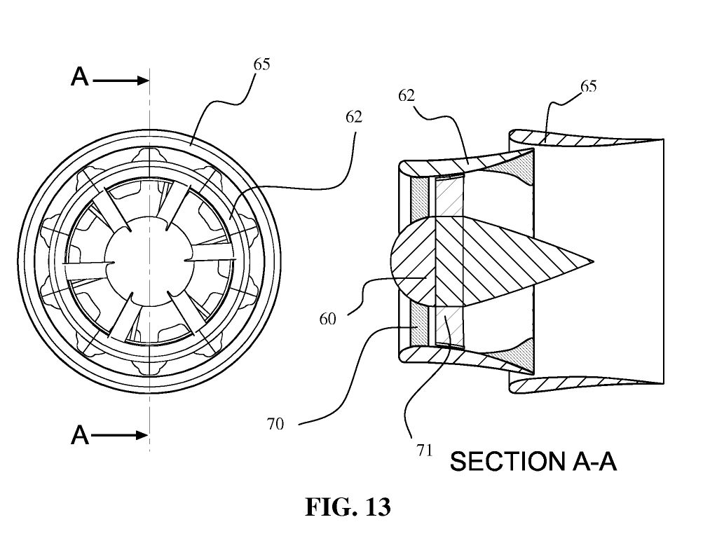

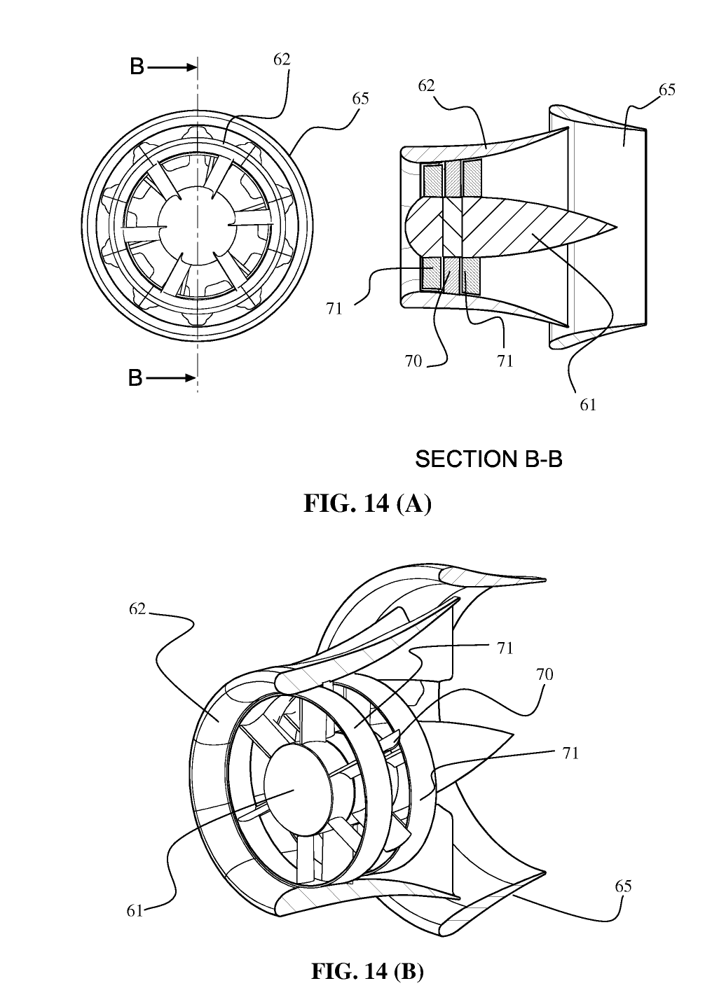

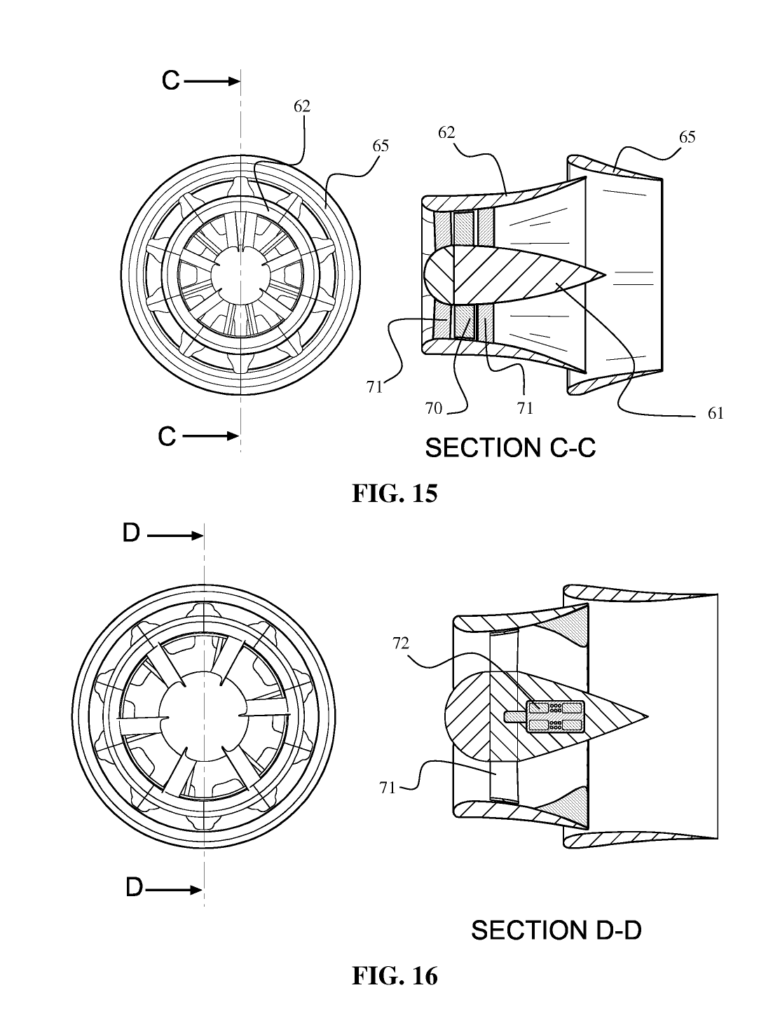

FIG. 13 presents a variations of Applicant's MEPS wherein the prop is made up of a row rotating blades 71 (hereinafter “ROTOR”) and guide vanes (hereinafter “STATOR”) 70 in conjunction. FIG. 13 shows a configuration with a single rotor and stator but the concept could include variants with multiple rotors and/or stators as shown in FIGS. 14A, 14B, 15, 16 to better control the flow and force produced for a wide range of velocities at the inlet. The rotors may, or may not, have the outer ring 71 attached for rigidity and strength. Stator rotor stages allow more energy to be added to the flow at higher efficiencies at higher aircraft flight speeds.

As shown in FIG. 17, MEPS may contain sound absorbing material 73 affixed to the inner surface of its shrouds to absorb and thus eliminate any the sound waves produced by either the power source or prop system. The sound absorption surface will be a porous plate with chambers behind designed to act as a Helmholtz resonator absorbing the key noise frequencies generated by the fan. The blade passage frequency will be one of the key sound frequencies to be absorbed.

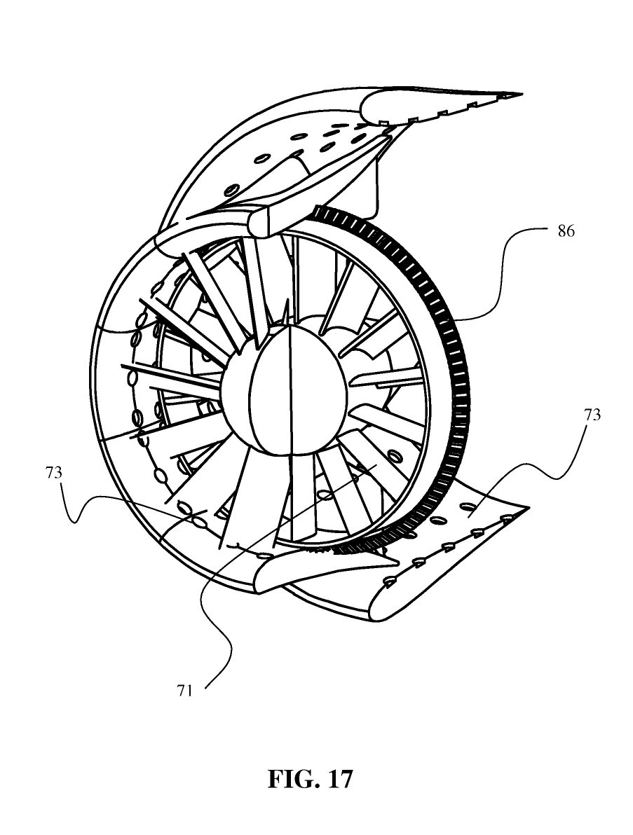

FIGS. 16, 17 present variations of Applicant's MEPS concept to include different means of transmitting power to the rotor. FIG. 16 shows power transmitted to the inner ring 72 containing the rotor 71. FIG. 17 shows power transmitted to the outer ring 86 containing the rotor 71. FIG. 17 shows a rack (gears) attached to the outer ring of the rotor 71. The rack 86 will be driven by a pinion gear. This outer drive mechanism will reduce the complexity of any gear box needed.

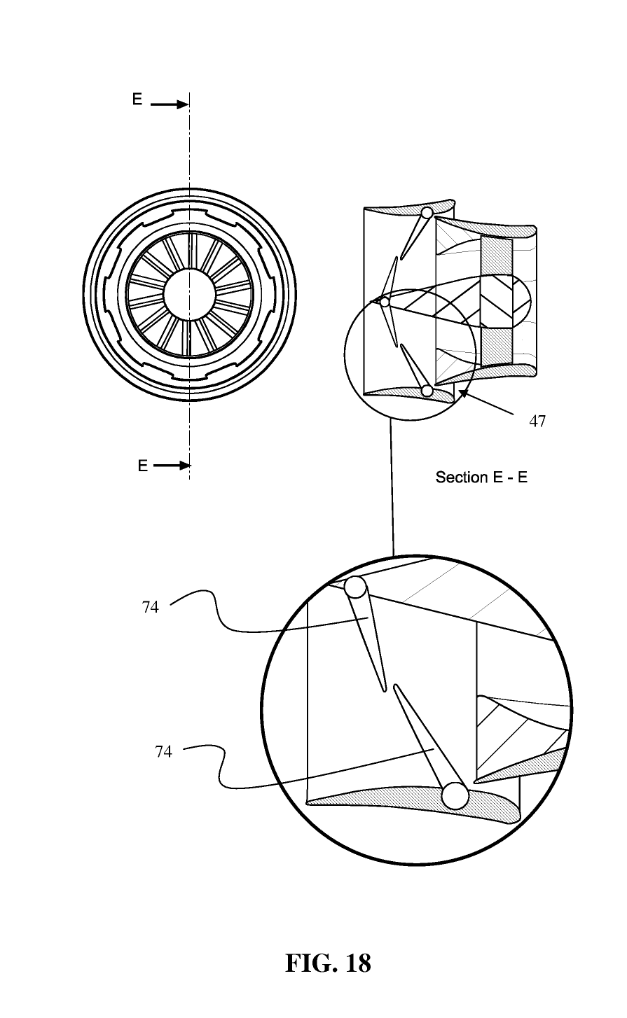

FIG. 18 present variations of Applicant's MEPS concept to include movable flow blockage doors 74 that are stored in the shrouds and/or the plug. The length of the flaps will be close to one half the radius of the shroud as shown. As such, the flaps can be used to divert the flow, or reverse the flow for the actuated positions shown in FIG. 18. The reverse flow will exit the inlet section of the ejector.

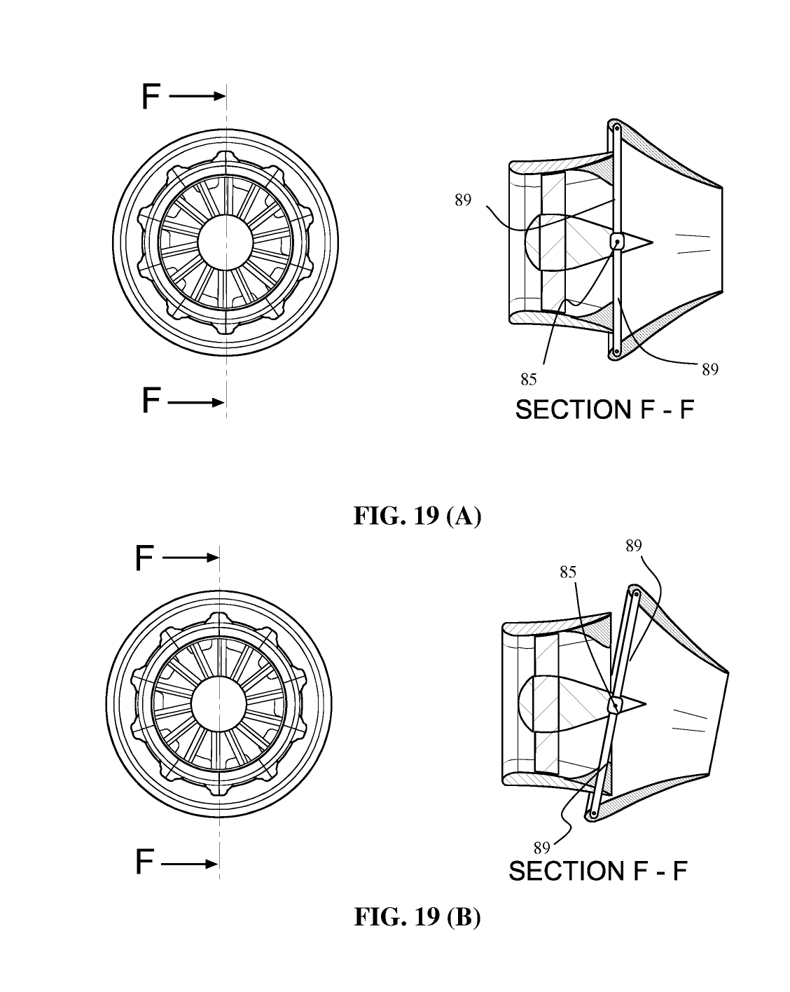

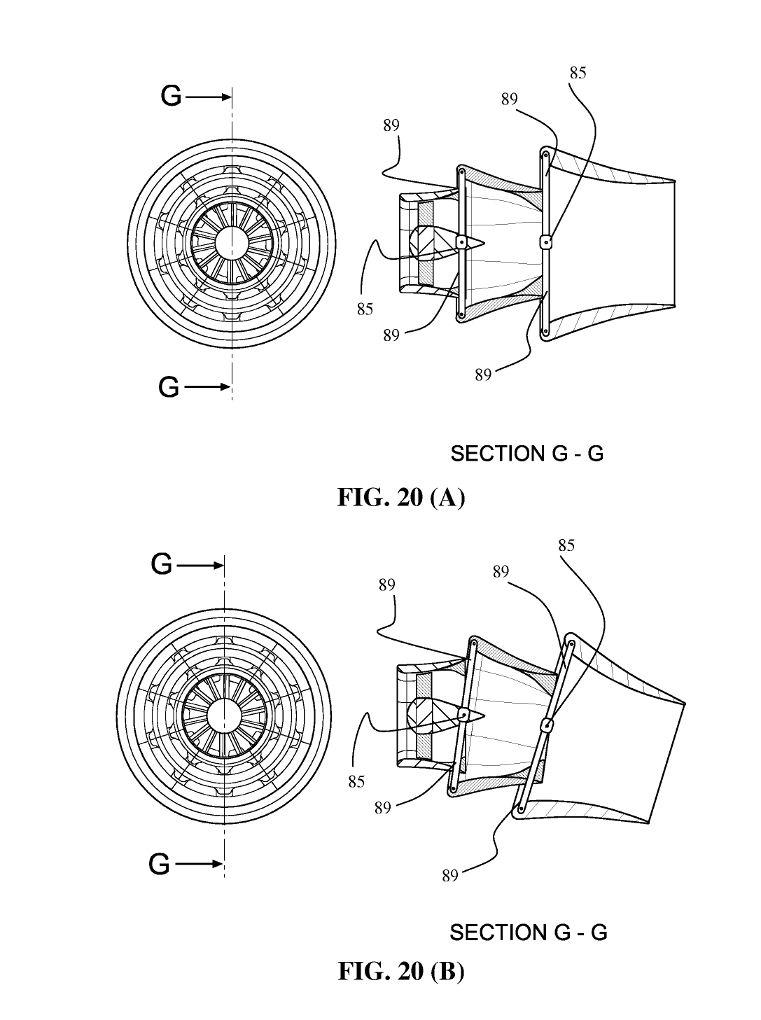

FIGS. 19A, 19B, 20A, 20B present variations of Applicant's MEPS wherein the mixer/ejector shrouds are articulated about the turbine shroud to allow swivel of the flow outlet so as to produce a force in a direction not aligned with that of the prop axis of rotation (herein after “VECTORING”). The mechanical drives, 89, for controlling the vectoring may be either interior to the shrouds or on their exterior surfaces. FIGS. 19A, 19B show a single stage vectoring system where the shroud is pivoted about an attachment point 85. FIGS. 20A, 20B show a two stage, articulating ejector system. The two stage system can be combined with rotation planes sequenced at 90 degrees to provide 360 degrees of thrust vectoring.

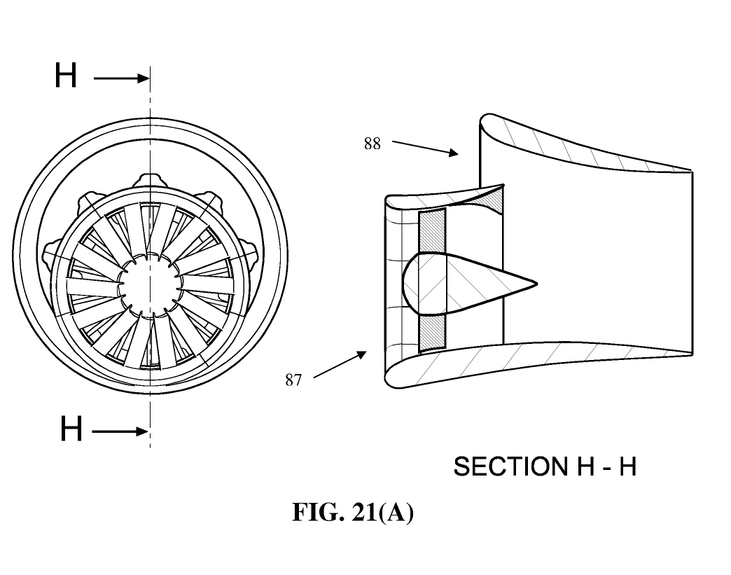

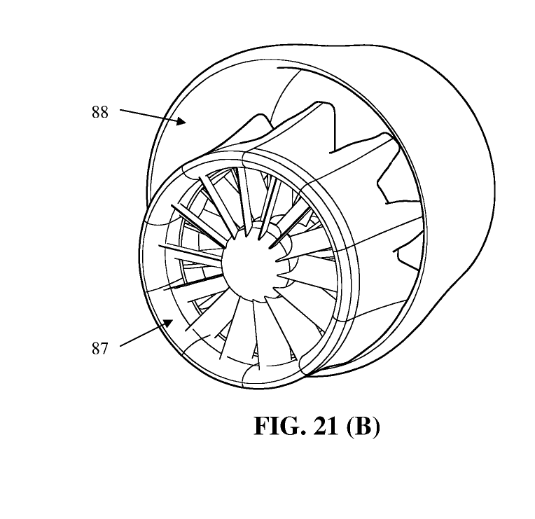

FIG. 21 (A) presents a variation of Applicant's MEPS wherein the system has two separate and independent inlet sections 87, and 88. The offset can allow the system to be mounted closer to the ground, or closer to aircraft structure. Test data has shown very little loss in performance when using such mixer ejector systems.

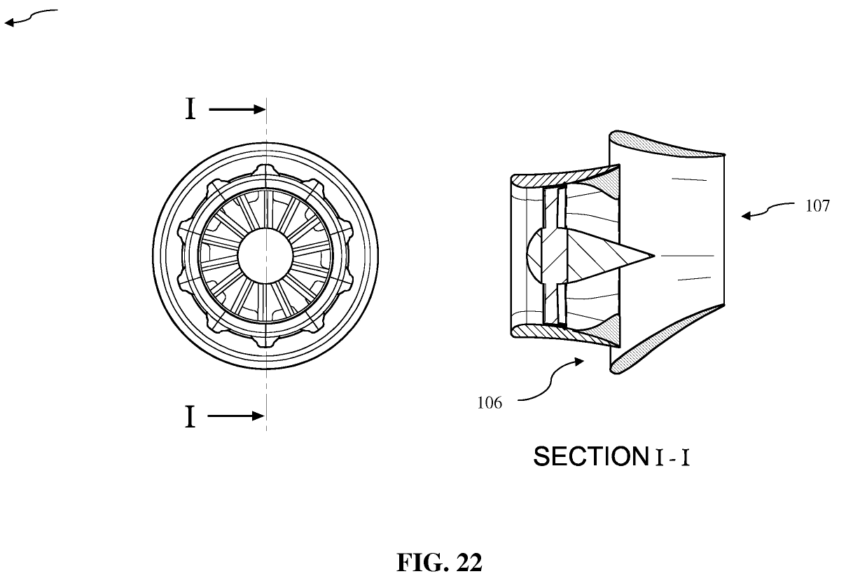

FIGS. 21A, 21B, 22, present variations of Applicant's MEPS wherein the axes of the various flow inlets 106 and outlets 107 are offset 87 so as to accommodate placement of other devices not directly associated with the MEPS . The offset shown in FIG. 22 could allow better, or closer, placement to support or aircraft structure.

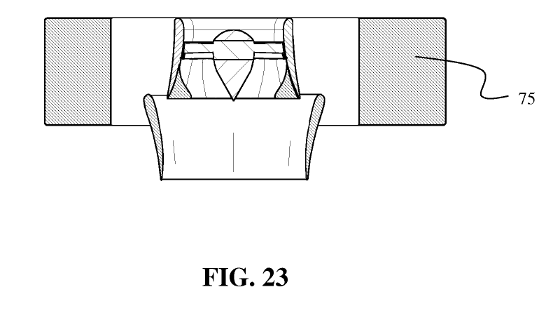

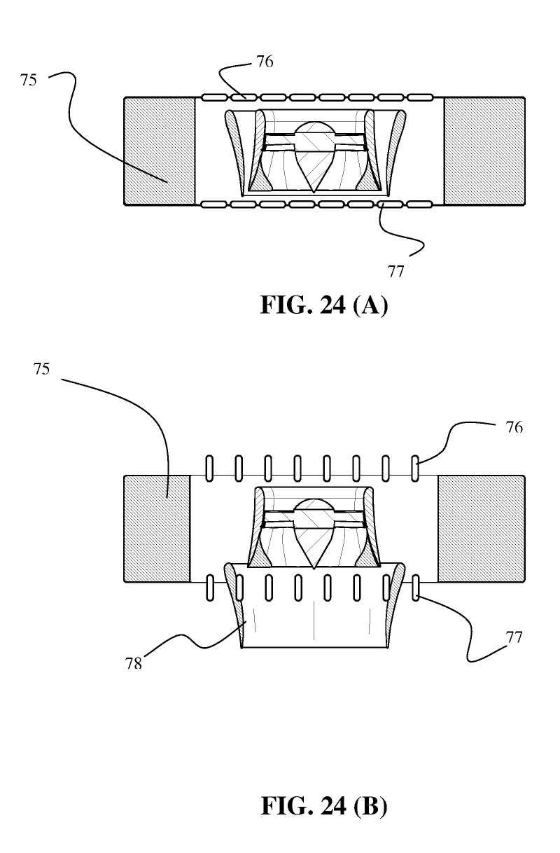

FIGS. 23, 24 present variations of Applicant's MEPS wherein it is embedded in another entity, such as an aircraft wing, 75 and may or may not contain inlet and outlet closure doors, 76 and 77 to be employed when MEPS is not operational. FIGS. 23, 24A show the entire MEPS system stowed in the wing. FIG. 24B shows the same configuration in which the ejector shroud, 78, is actuated so as to slide outward from the wing or entity 75 when MEPS is made operational. The stowed position provides lower airplane cruise drag. The actuated configuration provides using the MEPS system for vertical takeoff and landing situations.

1. A device for generating force at low speed using air, water or other fluids comprising a shrouded axial flow propeller with a single or multistage mixer-ejector pump that employs advanced fluid mixing devices, such as mixer lobes or slots, incorporated into the exhaust system of the propeller shroud.

2. A device for generating force at low speed using air, water or other fluids comprising:
a. an aerodynamically contoured primary shroud with a circular or non-circular inlet and outlet, surrounding a propeller;
b. an aerodynamically contoured center-body;
c. a propeller rotor to generate thrust
d. a single or multi-stage ejector pump with circular or non-circular inlets and outlets, incorporated into the exhaust system of the propeller shroud;
e. ejector shrouds with circular or non-circular inlets and outlets

3. A device for generating force at low speed using air, water or other fluids comprising:
a. an aerodynamically contoured primary shroud with a circular or non-circular inlet and outlet, surrounding a propeller;
b. an aerodynamically contoured center-body;
c. a propeller system made up of one or more stator rows, and one or more rotor blade rows that are mechanically linked at their inner rim to a power source;
d. a single or multi-stage ejector pump incorporated into the exhaust system of the propeller shroud.
e. ejector shrouds with circular or non-circular inlets and outlets that are aerodynamically cambered to increase flow through the propeller rotor.

4. A device for generating force at low speed using air, water or other fluids comprising:
a. an aerodynamically contoured primary shroud with advanced fluid mixing devices, such as mixer lobes or slots incorporated in its terminus region and circular or non-circular inlet and outlet, surrounding a propeller;
b. an aerodynamically contoured center-body;
c. a propeller made up of one or more stator rows, and one or more rotor blade rows that are mechanically linked at their inner rim to a power source;
d. a single or multi-stage mixer-ejector pump with advanced fluid mixing devices, such as mixer lobes or slots incorporated in its terminus regions, incorporated into the exhaust system of the propeller shroud;
e. ejector shrouds with circular or non-circular inlets and outlets that are aerodynamically cambered to increase flow through the propeller rotor.

5. The system of claim 2 wherein the shrouds include sound absorption materials on portions of their interior surfaces.

6. The system of claim 2 wherein the interior surfaces of the shrouds contain movable blocker surfaces capable of protruding into the flow for impeding and/or diverting the direction of the flow so as to reduce or divert the thrust produced by the system.

7. The system of claim 2 wherein the stator blade rows and/or rotor blade rows are mechanically adjustable to reverse the flow and force direction, control exhaust flow swirl, aerodynamic roll and/or steering of the system.

8. The system of claim 2 wherein the ejector stages are articulated to allow swivel of the exhaust flow direction and thrust vectoring.

9. The system of claim 2 wherein the center axes of the flow inlets and outlets of the propeller, propeller shroud and ejector shroud are not coincident.

10. The system of claim 2 wherein each ejector shroud has one or more independent inlets and outlets.

11. The system of claim 2 wherein propeller shroud and ejector shrouds are embedded in a larger vehicle or apparatus.

12. The system of claim 3 wherein the shrouds include sound absorption materials on portions of their interior surfaces.

13. The system of claim 3 wherein the interior surfaces of the shrouds contain movable blocker surfaces capable of protruding into the flow for impeding and/or diverting the direction of the flow so as to reduce or divert the thrust produced by the system.

14. The system of claim 3 wherein the stator blade rows and/or rotor blade rows are mechanically adjustable to reverse the flow and force direction, control exhaust flow swirl, aerodynamic roll and/or steering of the system.

15. The system of claim 3 wherein the ejector stages are articulated to allow swivel of the exhaust flow direction and thrust vectoring.

16. The system of claim 3 wherein the center axes of the flow inlets and outlets of the propeller, propeller shroud and ejector shroud are not coincident.

17. The system of claim 3 wherein each ejector shroud has one or more than independent inlets and outlets.

18. The system of claim 3 wherein propeller shroud and ejector shrouds are embedded in a larger vehicle or apparatus.

19. The system of claim 4 wherein the shrouds include sound absorption materials on portions of their interior surfaces.

20. The system of claim 4 wherein the interior surfaces of the shrouds contain movable blocker surfaces capable of protruding into the flow for impeding and/or diverting the direction of the flow so as to reduce or divert the thrust produced by the system.

21. The system of claim 4 wherein the stator blade rows and/or rotor blade rows are mechanically adjustable to reverse the flow and force direction, control exhaust flow swirl, aerodynamic roll and/or steering of the system.

22. The system of claim 4 wherein the ejector stages are articulated to allow swivel of the exhaust flow direction and thrust vectoring.

23. The system of claim 4 wherein the center axes of the flow inlets and outlets of the propeller, propeller shroud and ejector shroud are not coincident.

24. The system of claim 4 wherein each ejector shroud has one or more than independent inlets and outlets.

25. The system of claim 4 wherein propeller shroud and ejector shrouds are embedded in a larger vehicle or apparatus.
